(19) United States
(12) Patent Application Publication
(10) Pub. No.: US 2010/0077443 A1
(43) Pub. Date: Mar. 25, 2010

(54) Electronic System and Method for Driving Electronic Device

(75) Inventor: Chin-Yu Wang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 12/555,441

(22) Filed: Sep. 8, 2009

(30) Foreign Application Priority Data
Sep. 23, 2008 (TW) 97136498

(51) Int. Cl. H04N 7/16; H04N 5/50; G06F 15/177

(52) U.S. Cl. 725/153; 348/731; 713/2; 348/E05.097

(57) ABSTRACT

An electronic system and a method for driving an electronic device are disclosed. The method for driving the electronic device includes steps as follows. A storage medium is provided. The storage medium has a file system accessible by a BIOS and stores program codes for driving the electronic device. Then, the electronic device is driven by a driver stored in the storage medium. Afterwards, stream data transmitted by the electronic device is received and outputted.

### RELATED APPLICATIONS

This application claims priority to Taiwan Application Serial Number 97136498, filed Sep. 23, 2008, which is herein incorporated by reference.

### BACKGROUND OF THE INVENTION

1. Field of the Invention

The invention relates to an electronic system and a method for driving an electronic device and, more particularly, to a method for driving the electronic device by a BIOS.

2. Description of the Related Art

A basic input/output system (BIOS) is an important interface between hardware and an operating system in a personal computer. The BIOS is the program recorded in a memory for controlling hardware components. If a computer does not have the BIOS, the hardware components are just parts without communication even they are assembled with one another. Only when the components communicate and coordinate with each other may they form the base of the whole system. The BIOS plays the role of a communicator and coordinator.

When the power is switched on, and before the operating system (such as DOS, Unix, or Windows) is entered, the first important work of the computer is to execute the BIOS codes. Thus, the BIOS makes the hardware components communicate with each other to form the system. The BIOS also checks if peripherals of the computer are in a normal condition. Furthermore, the BIOS initializes and tests the hardware to make sure that the hardware may operate normally. After the initialization setting and the testing process, the BIOS reads booting program codes in the hard disk to make the operating system (which is software) control the computer.

The BIOS is also an important interface between the operating system and the hardware in the computer system. For example, a video graphics array (VGA) BIOS includes control commands, a product logo and other information. The information is recorded in a read only memory (ROM) or a flash chip directly by the VGA card manufacturer, and it plays the role of a communicator and coordinator between the operating system and the VGA card.

However, most of the electronic devices in the market cannot be operated by the BIOS directly, and they are operated by the operating system. Thus, after the user boots the computer, he or she cannot use the electronic device until the computer enters the operating system, which wastes much time. Therefore, a new method which may drive the electronic device faster is needed.

### BRIEF SUMMARY OF THE INVENTION

One aspect of the invention provides a method for driving an electronic device in which a peripheral electronic device is driven in the BIOS mode directly. In addition, data transmitted by the electronic device is used for the user to listen or watch.

According to an embodiment of the invention, the method for driving the electronic device includes the steps as follows. A storage medium is provided. The storage medium has a file system accessible by the BIOS and stores program codes for driving the electronic device. The electronic device is driven by a driver stored in the storage medium. Then, the stream data transmitted by the electronic device is received and outputted.

Another aspect of the invention provides an electronic system which may drive the peripheral electronic device in the BIOS mode directly and output the data played by the electronic device to allow the user to listen or watch.

According to another embodiment of the invention, the electronic system includes a memory, a BIOS module stored in the memory, an electronic device, a storage medium and a display device. The electronic device outputs a stream data for the BIOS module to process. The storage medium has a file system accessible by the BIOS module and stores a driver of the electronic device for the BIOS module to drive the electronic device. The display device is controlled by the BIOS module to display the stream data outputted by the electronic device.

According to the above embodiment, the user may drive the peripheral electronic device via the BIOS directly, and the electronic device may be driven before the computer enters an operating system. Thus, the convenience is improved.

### BRIEF DESCRIPTION OF THE DRAWINGS

FIG. 1 is a block diagram showing the electronic system in an embodiment of the invention;

FIG. 2 is a block diagram showing the electronic system in another embodiment of the invention;

FIG. 3 is a flow chart showing the method for driving the electronic device in an embodiment of the invention; and

FIG. 4 is a flow chart showing the method for driving the electronic device in another embodiment of the invention.

### DETAILED DESCRIPTION OF THE EMBODIMENTS

According to an electronic system and a method for driving an electronic device in the following embodiments, a BIOS may drive a peripheral electronic device directly, and thus the electronic device may be driven before the computer enters an operating system. Thus, the convenience is improved.

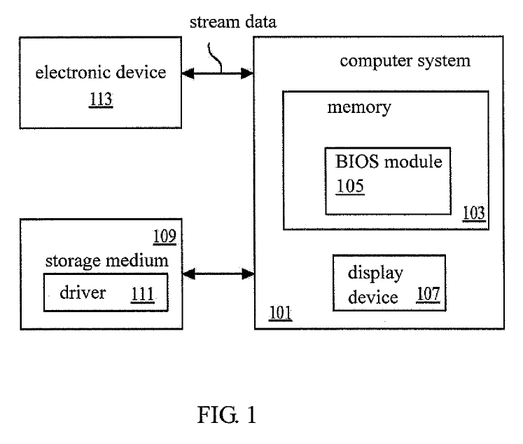

FIG. 1 is a block diagram showing the electronic system in an embodiment of the invention. As shown in FIG. 1, the electronic system includes a computer 101, an electronic device 113 and a storage medium 109. The computer 101 includes a memory 103 and a display device 107. The memory 103 stores a BIOS module 105.

The storage medium 109 such as a flash memory has a file system such as NTFS, FAT32 or INT13 which may be accessible by the BIOS module 105. The storage medium 109 stores a driver 111 of the electronic device 113 to allow the BIOS module 105 to drive the electronic device 113 using the driver 111.

The storage medium 109 herein is just an embodiment, and it may be connected to the electronic device 113 or disposed in the computer 101.

After driven, the electronic device 113 may be used by the computer 101 to output stream data to the computer 101 to allow the BIOS module 105 to subsequently process the stream data. For example, the BIOS module 105 may control the display device 107 to display the stream data.

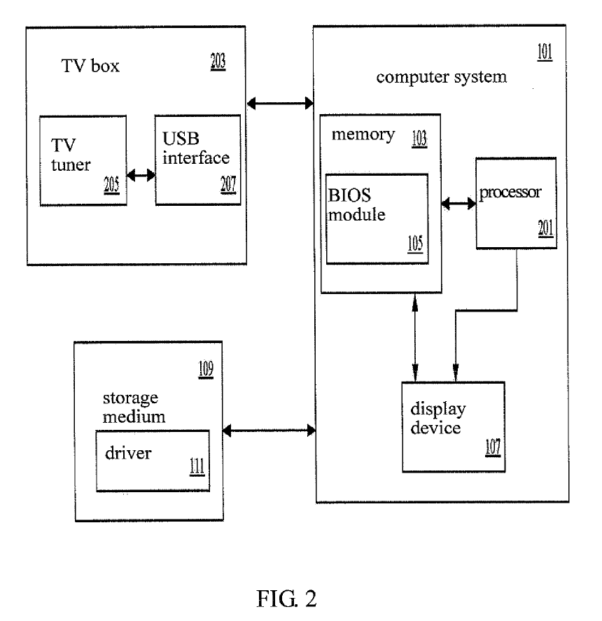

FIG. 2 is a block diagram showing the electronic system in another embodiment of the invention. As shown in FIG. 2, the electronic system includes a computer 101, a TV box 203 and a storage medium 109. The computer 101 includes a memory 103, a display device 107 and a processor 201. The BIOS module 105 is located in the memory 103.

Similar to the electronic system in FIG. 1, the storage medium 109 has a file system accessible by the BIOS module 105 to allow the BIOS module 105 to access the driver 111 stored in the storage medium 109 to drive the TV box 203. The driver 111 stored in the storage medium 109 has a preset file name. Thus, the BIOS module 105 may search the preset file name to capture the driver 111.

The TV box 203 includes a TV tuner 205 and a universal serial bus (USB) interface 207. The TV tuner 205 selects a channel preferred by the user and receives information of the channel. For example, the TV turner 205 may first amplify the radio frequency (RF) channel information, and then it may select the preferred channels and filter unwanted channels to prevent the unwanted channels from disturbing the preferred channels during a down-converting process. Afterwards, the filter RF channel information is down converted to an intermediate frequency.

The TV tuner 205 may transmit the processed channel information to the USB interface 207. The USB interface 207 may convert the channel information to stream data. The stream data is data stream with dynamic audio and video compression (for example, it's format may be the MPEG1, MPEG2, MPEG4, H.264 and one of other formats), and then the stream data is transmitted to the BIOS module 105.

In the process of transmitting the stream data to the BIOS module 105, a decoder may be used to decode the stream data to a display chip. In the embodiment, the stream data is transmitted to the BIOS module 105, which means a decoding module is in the BIOS module 105. In another embodiment, the decoding module also may be disposed with the driver 111 in the storage medium 109, as long as the BIOS module 105 may call the decoding module.

Besides the TV tuner 205 and the USB interface 207, the storage medium 109 storing the driver also may be disposed in the TV box. Thus, additional hardware for disposing the storage medium 109 is not needed. Therefore, the BIOS module 105 may access the driver 111 via the USB of the TV box 203.

When the computer 101 receives the stream data transmitted by the TV box 203, the BIOS module 105 may operate a processor 201 to decode and convert the stream data. For example, the stream data whose format is MPEG1, MPEG2, MPEG4 or H.264 is decoded first. Then, the decoded stream data is converted to an input signal acceptable by the display device whose format is, for example, the RGB, DVI, YCbCr or HDTV. The processor 201 may be a video graphics array (VGA) processor or a central processing unit (CPU). When the stream data is converted to data with a format such as the RGB, DVI or HDTV, the BIOS module 105 may further control the display device 107 to display the data having a signal format such as RGB, DVI, YCbCr or HDTV.

The storage medium 109 may be combined with the TV box 203 to form a storage medium 109 having the USB interface, the TV tuner and a file system accessible by the BIOS module 105.

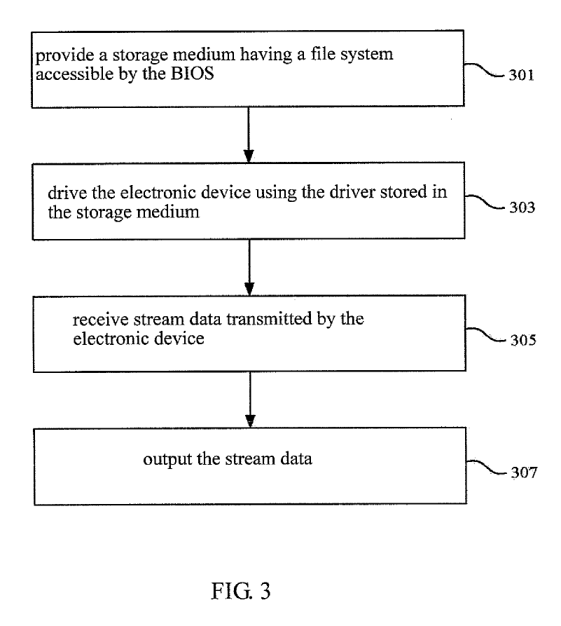

FIG. 3 is a flow chart showing the method for driving the electronic device in an embodiment of the invention. In the method for driving the electronic device, first, a storage medium is provided (step 301), and the storage medium has a file system accessible by the BIOS and stores a driver of the electronic device. Before the step of providing a storage medium, the storage medium is formatted to make the storage medium have the file system identifiable by the BIOS. Then, the driver stored in the storage medium is used to drive the electronic device (step 303). Afterwards, the stream data transmitted by the electronic device is received (step 305) and outputted (step 307).

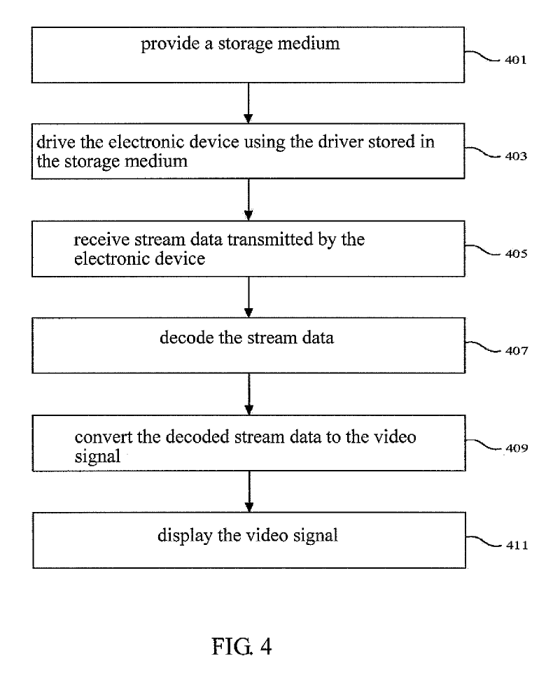

FIG. 4 is a flow chart showing the method for driving the electronic device in another embodiment of the invention. As shown in FIG. 4, in the method for driving the electronic device. First, a storage medium is provided (step 401), and the storage medium is already formatted by a formatting program to be a file system identifiable by the BIOS such as the file system with the format NTFS, FAT32, INT13. Then, the BIOS drives the electronic device using the driver stored in the storage medium (step 403). After the electronic device is driven, the BIOS may receive the stream data transmitted from the electronic device (step 405) and decode the stream data (step 407). For example, the stream data whose format is MPEG1, MPEG2, MPEG4, H.264 and one of other formats are decoded. Then, the decoded stream data is converted to the video signal (step 409) such as the video data having signal format such as RBG, DVI, YCbCr or HDTV. Then, the video data is played (step 411).

According the electronic system and the method for driving the electronic device in the embodiments, the peripheral electronic device may be driven directly by the BIOS, and then the electronic device may be driven before the computer enters the operating system. Thus, the convenience is improved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for driving an electronic device, comprising:
providing a storage medium having a file system accessible by a basic input/output system (BIOS) and storing a driver of the electronic device;
driving the electronic device by the driver stored by the storage medium;
receiving stream data transmitted by the electronic device; and
outputting the stream data.

2. The method for driving the electronic device according to claim 1, wherein before the step of providing a storage medium, the method further comprises formatting the storage medium to make the storage medium have the file system identifiable by the BIOS.

3. The method for driving the electronic device according to claim 1, wherein the storage medium storing the driver is a flash memory, and the file system of the flash memory is NTFS, FAT32 or INT13.

4. The method for driving the electronic device according to claim 1, wherein the driver has a preset file name for the BIOS to search and capture.

5. The method for driving the electronic device according to claim 1, wherein the electronic device is a TV box, and the TV box is driven by the BIOS using the driver stored in the storage medium.

6. The method for driving the electronic device according to claim 5, wherein the TV box comprises a universal serial bus (USB) interface for transmitting the stream data generated by the TV box to the BIOS.

7. The method for driving the electronic device according to claim 5, wherein the TV box comprises a TV tuner for selecting one of a plurality of channels preferred by the user and receiving information of the channel.

8. The method for driving the electronic device according to claim 5, wherein the TV box comprises a storage medium for storing the driver of the TV box.

9. The method for driving the electronic device according to claim 1, wherein the step of outputting the stream data comprises:
decoding the stream data;
converting the decoded stream data to a video signal; and
playing the video signal.

10. The method for driving the electronic device according to claim 9, wherein the BIOS controls a video graphics array (VGA) processor to decode and convert the stream data.

11. The method for driving the electronic device according to claim 10, wherein the format of the stream data comprise: MPEG1, MPEG2, MPEG4 or H.264, and the VGA processor converts the stream data to the video signal whose format is RGB, DVI, YCbCr, HDTV or one of other formats.

12. An electronic system comprising:
a memory;
a BIOS module stored in the memory;
an electronic device outputting stream data for the BIOS module to process;
a storage medium having a file system accessible by the BIOS module and storing a driver of the electronic device to allow the BIOS module to drive the electronic device using the driver; and
a display device controlled by the BIOS module to display the stream data outputted by the electronic device.

13. The electronic system according to claim 12, wherein the storage medium is a flash memory, and the file system of the flash memory is NTFS, FAT32 or INT13.

14. The electronic system according to claim 12, wherein the electronic device is a TV box which is driven by the BIOS module using the driver stored in the storage medium.

15. The electronic system according to claim 14, wherein the TV box comprises a USB interface for transmitting the stream data generated by the TV box to the BIOS module.

16. The electronic system according to claim 14, wherein the TV box comprises a TV tuner for receiving and selecting one of a plurality of channels preferred by the user.

17. The electronic system according to claim 14, wherein the TV box comprises the storage medium for storing the driver of the TV box.

18. The electronic system according to claim 12, further comprising a VGA processor controlled by the BIOS module for decoding and converting the stream data outputted by the electronic device.

19. The electronic system according to claim 12, further comprising a central processing unit (CPU) controlled by the BIOS module for decoding and converting the stream data outputted by the electronic device.
